(19) United States
(12) Patent Application Publication
(10) Pub. No.: US 2026/0359462 A1
(43) Pub. Date: Nov. 12, 2026

(54) METHOD FOR COMMUNICATING AN INDICATION OF CORRECT OPERATION BETWEEN TWO ISOLATED PROCESSORS

(71) Applicant: SAFRAN ELECTRONICS & DEFENSE, PARIS (FR)

(72) Inventors: Mathieu CONQ, MOISSY CRAMAYEL (FR); Nicolas MARTI, MOISSY CRAMAYEL (FR); Gael RAKOTOARIVELO, MOISSY CRAMAYEL (FR)

(21) Appl. No.: 19/125,134

(22) PCT Filed: Oct. 23, 2023
(86) PCT No.: PCT/FR2023/051655

§ 371 Date: Apr. 28, 2025

(30) Foreign Application Priority Data
Oct. 28, 2022 (FR) FR2211281

(51) Int. Cl. G06F 21/60; B64C 13/00

(52) U.S. Cl. CPC G06F 21/606; B64C 13/00

(57) ABSTRACT

A communication method for a first processor implementing a maintenance function for a second processor, the second processor implementing an engine control function, the first processor and the second processor being isolated in communication by an FPGA, the FPGA including a bidirectional first link with the second processor, a unidirectional second link to the first processor, a unidirectional third link from the first processor, the method including the FPGA receiving a frame sent by the first processor, the FPGA evaluating a predefined parameter so as to obtain a value of the predefined parameter dependent on the received frame, the second processor accessing the value of the predefined parameter via the FPGA.

### TECHNICAL FIELD OF THE INVENTION

The technical field of the invention is that of cybersecurity, and in particular secure communication between on-board devices in aeronautics.

The present invention relates to a communication method between two isolated processors and in particular a communication method in which one of the two processors isolated for reasons of cybersecurity knows a state of the other processor despite their isolation.

### TECHNOLOGICAL BACKGROUND OF THE INVENTION

Conventionally, in aircraft, an engine is controlled by a calculator known as a “FADEC” (Full Authority Digital Engine Control). The FADEC interfaces between the aircraft cockpit and an aircraft engine, ensures electronic protection for the engine and reduces load on the pilot. It enables the aircraft propulsion system to be monitored, protected and controlled in real time.

A FADEC is represented in FIG. 1. The FADEC 1 comprises at least two processors: a first processor 11 performing a control function FC for controlling the engine, and a second processor 12 performing a maintenance function FM. The maintenance processor 12 makes it possible to maintain, for example correct or update, the control function FC and therefore the control processor 11. Data from engine sensors can for example be sent by the control processor 11 to the maintenance processor 12. The maintenance processor 12 then stores the data received for analysis after the aircraft has flown, for example by a maintenance operator. In such a case, the maintenance processor 12 also has to let the control processor 11 know that the maintenance processor 12 is ready to receive data to be stored.

With the advent of new cybersecurity standards applicable to aeronautical equipment, the maintenance function FM also acts as a cybersecurity barrier, isolating the control function FC, which is a critical function, from the outside world. Indeed, a malicious actor might want to take control of the control function FC via the maintenance function FM. The barrier function of the maintenance function FM makes it possible to overcome this problem.

This barrier function implies that a communication from the maintenance processor 12 to the control processor 11 is interrupted in operational mode, that is, when the control processor 11 is actually controlling the engine. However, communication from the control processor 11 to the maintenance processor 12 has to be retained to be able to continuously record flight parameters. These conditions are met by virtue of the addition of an FPGA. An FPGA (Field-Programmable Gate Array) is a simple programmable electronic circuit. The FPGA, as represented in FIG. 1, is an intermediary between the control processor 11 and the maintenance processor 12.

The processors 11 and 12 and the FPGA are connected by links L1 to L3, which are, for example, and without being limited thereto, ethernet, CAN, UART, SPI, I2C, etc. type links, as is well known to the person skilled in the art. The links L1 to L3 may also be called as “connections”.

FIG. 1 shows one embodiment of the FADEC in maintenance mode. FIG. 2 shows one embodiment of the FADEC in operational mode.

In operational mode, interruption of the link L3 prevents a malicious actor from controlling the control function FC of the control processor 11 via the maintenance function FM of the maintenance processor 12. The interruption is a software interruption, that is, via the link L1, the processor 11 does not have access to data sent by the processor 12 via the link L3. The link L3 may be functional, for example, but the FPGA may not listen to the link and therefore not read data received via the link L3. In operational mode, the link L2 is functional, to be able to indicate to the maintenance processor 12 that the control function 11 implemented by the control processor 11 is operating correctly.

Interruption of the communication L3 from the maintenance processor 12 to the control processor 11 has an undesirable consequence for the control processor 11: in operational mode, the control processor 11 does not know whether the maintenance function FM implemented by the maintenance processor 12 is operating correctly.

One solution provided in prior art is to add a communication link L4 directly between the control processor 11 and the maintenance processor 12. This link L4 is a link allowing only predefined discretes to be transited, and only in one direction: from the maintenance processor 12 to the control processor 11. This link L4 comprises, for example, one electrical wire per discrete transmitted, the discretes then being interpreted by the control function FC receiving them. These predefined discretes, also called life witnesses TV, can for example indicate state of the maintenance processor 12. The two processors 11 and 12 are then always isolated from the point of view of cybersecurity, because it is considered that sending erroneous or malicious discretes or sending predefined discretes does not disturb the control function FC of the control processor 11. This solution is unsatisfactory in that it requires a different architecture and additional components, and special programming of the control function FC to learn how to manage these life witnesses TV. This penalises reliability and volume of the FADEC.

Additionally, this solution is not very robust to simple faults. Indeed, a failure of the maintenance function FM can lead, combined with electrical noise, to behaviour similar to a fault-free case. The fault will then not be detected by the control function FC. It would be possible to improve detection, using a precise duty factor and/or discrete change frequency, but this would require the implementation of a more complex detection function.

There is therefore a need in a FADEC, for the control function, to have access to information relating to the state of the maintenance function in operational mode without adding components specific to the transmission of this information.

### SUMMARY OF THE INVENTION

The invention provides a solution to the problems discussed previously, by enabling the control function of a FADEC to have access to reliable information relating to the state of the maintenance function without adding components specific to the transmission of this information.

One aspect of the invention relates to a method for communicating an indication of correct operation from a first processor to a second processor, the first processor implementing a maintenance function for maintaining the second processor, the second processor implementing a control function for controlling an engine, the first processor and the second processor being communicatively isolated by an FPGA, the FPGA comprising:
a first bidirectional communication link with the second processor,
a second unidirectional communication link from the FPGA to the first processor,
a third unidirectional communication link from the first processor to the FPGA,
   the method comprising at least the steps of:
Receiving by the FPGA, via the third link, at least one frame sent by the first processor,
Evaluating, by the FPGA, a predefined parameter to obtain a value of the predefined parameter, the value of the predefined parameter depending on the frame received,
Accessing, by the second processor, via the first link, the value of the predefined parameter, via the FPGA.

By virtue of the invention, it is possible, for a processor implementing a control function for controlling an engine, to know the state of a maintenance processor implementing a maintenance function. The invention enables the control processor to have the state of the maintenance processor while maintaining the link between the two processors interrupted by the FPGA which communicatively isolates them.

By “two processors communicatively isolated by the FPGA”, it is meant that each communication from one of the two processors to the other of the two processors is necessarily received by the FPGA and then transmitted by the FPGA to the recipient processor as a function of a communication policy. By virtue of this isolation, in operational mode, the maintenance processor cannot transmit any communication to the control processor because the FPGA is configured not to transmit communications in this direction.

By not transmitting communications from the maintenance processor to the control processor, the invention makes it possible to maintain this isolation, which is necessary to guarantee a high level of security. By transmitting a parameter dependent on the communications received, the invention makes it possible not to transmit the communications received, and therefore to maintain the isolation, while informing the control processor of the state of the maintenance processor, without any additional architecture relative to the already existing system.

Further to the characteristics just discussed in the preceding paragraph, the method according to one aspect of the invention may have one or more complementary characteristics from among the following, considered individually or according to any technically possible combination:
the FPGA is configured to implement an operational mode in which frames received via the third link are deleted by the FPGA after the evaluation step, and a maintenance mode in which frames received via the third link are stored by the FPGA after the reception step, the method being implemented in operational mode.
the parameter is a counter for the number of frames received, the counter being incremented on each new reception of a frame.
the method further comprises, prior to the evaluation step, a step of verifying, by the FPGA, integrity of each frame received via the third link, the evaluation step being carried out, for each frame received, only if the frame received has integrity.
the integrity verification step comprises evaluating a cyclic redundancy check included in the frame or a checksum included in the frame.
the engine controlled by the control function is an aircraft engine.

Another aspect of the invention relates to a system configured to implement the method according to the invention, the system comprising:
an aircraft engine,
a first processor
a second processor,
an FPGA comprising:
   a first bidirectional communication link with the second processor,
   a second unidirectional communication link from the FPGA to the first processor,
   a third unidirectional communication link from the first processor to the FPGA,
the first processor implementing a maintenance function for maintaining the second processor, the second processor implementing a control function for controlling the aircraft engine, the first processor and the second processor being communicatively isolated by the FPGA.

Another aspect of the invention relates to a computer program product comprising instructions which, when the program is executed by a computer, cause the same to implement the method according to the invention.

Another aspect of the invention relates to a computer-readable recording medium comprising instructions which, when executed by a computer, cause the same to implement the method according to the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a schematic representation of a system of the state of the art in maintenance mode.

FIG. 2 shows a schematic representation of a system of the state of the art in operational mode.

FIG. 3 shows a schematic representation a system implementing the method of the invention.

FIG. 4 shows a schematic representation of the method of the invention.

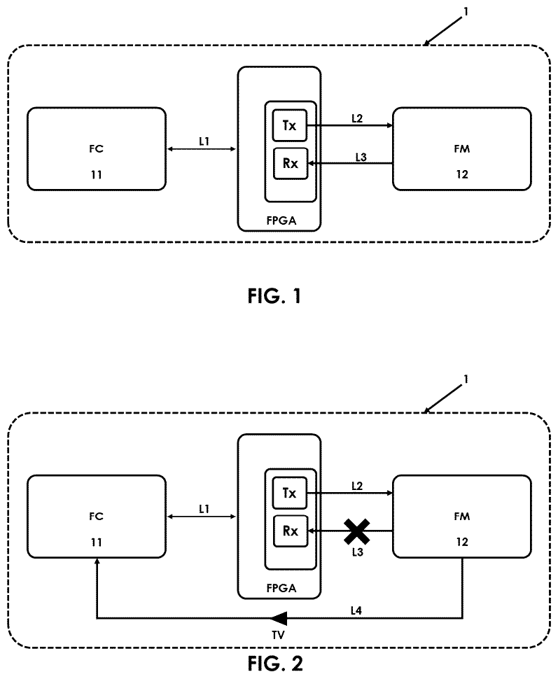

### DETAILED DESCRIPTION

Unless otherwise specified, a same element appearing in different figures has a single reference.

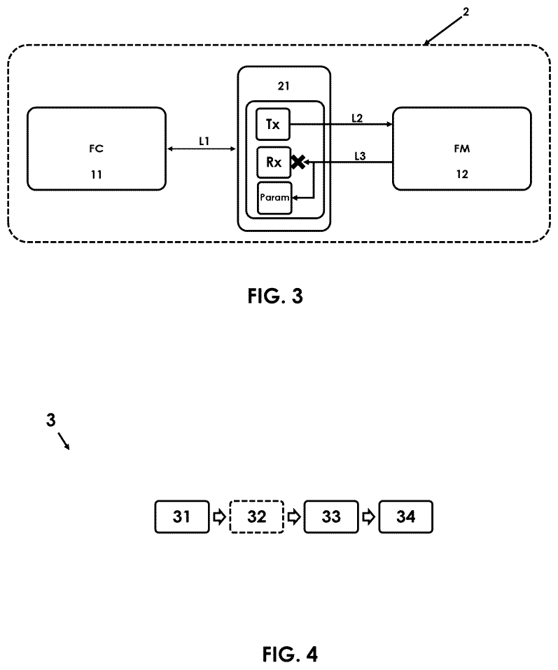

FIG. 3 shows a schematic representation of a system according to the invention.

The system 2 according to the invention comprises a first processor 12 and a second processor 11. The first processor 12 implements a maintenance function for maintaining the second processor 11. It will thus be called the “maintenance processor 12”. The second processor 11 implements a control function for controlling an engine. It will thus be called the “control processor 11”. The controlled engine is, for example, an aircraft engine. The system 2 is then on board the aircraft comprising the aircraft engine.

A processor implements a function when it executes instructions stored by a memory, the instructions causing the processor to implement method steps corresponding to the function to be implemented.

The control processor 11 and the maintenance processor 12 are separated by an FPGA 21, which communicatively isolates the two processors 11 and 12, that is, the two processors 11 and 12 can only communicate via the FPGA 21.

The FPGA 21 enables the two processors 11 and 12 to communicate via communication links L1 to L3, as in prior art. The FPGA 21 is then configured to transmit, or not, frames from one processor to the other processor, thus performing the function for communicatively isolating the processors 11 and 12.

The system 2 comprises:
a first bidirectional communication link L1 between the FPGA 21 and the control processor 11,
a second unidirectional communication link L2 from the FPGA 21 to the maintenance processor 12,
a third unidirectional communication link L3 from the maintenance processor 12 to the FPGA 21.

The FPGA 21 comprises a data reception function Rx via the third link L3 and a data transmission function Tx via the second link L2.

The system 2 can operate in operational mode and maintenance mode.

In maintenance mode, all the communication links L1 to L3 are functional, that is, they can allow transit of a communication.

In operational mode, the link L3 is interrupted by the FPGA, this interruption not being a physical but a software interruption. The interruption is a software interruption, that is, via the link L1, the processor 11 does not have access to the data sent by the processor 12 via the link L3. The link L3 may, for example, be in a physical state to make communications transit, but the FPGA may then not read the link and therefore not read the data received via the link L3. In operational mode, the link L2 is functional, to be able to indicate to the maintenance processor 12 that the control function 11 implemented by the control processor 11 is operating correctly. The data reception function Rx is stopped in operational mode.

By “correct operation” or “is operating correctly” , it is meant “normal” or “expected” operation, that is, complying with an operating standard.

The mode change is carried out by driving the FPGA 21, which, for this, implements a mode change function for changing mode of the system 2. Driving from one mode to the other among the operational and maintenance modes of the FPGA 21 is implemented by the control processor 11.

The method according to the invention is represented in FIG. 4 and comprises at least three steps. The method according to the invention is implemented by the system 2.

The method 3 according to the invention enables the control processor 11 to have access to an operation indicator of the maintenance processor 12 in operational mode. According to the invention, the operation indicator of the maintenance processor 12 is created by the FPGA 21, from frames sent by the maintenance processor 12.

For this, the method 3 according to the invention comprises a first step 31 of receiving, by FPGA 21, at least one frame sent by maintenance processor 12. This frame is sent by the maintenance processor 12 via the third unidirectional link L3. The communication links L1 to L3 comply with a communication protocol, for example selected from Ethernet, CAN, UART, SPI, 12C, etc. The frame sent by the maintenance processor 12 complies with the same protocol. The frame is preferably a predefined frame, that is, a frame known to the maintenance processor 12 and the FPGA 21. For example, a predefined frame has a particular structure, known to the transmitter and the receiver. A predefined frame does not necessarily have a predefined content. This step 31 may involve receiving several simultaneous frames.

Upon receiving the frame, the FPGA 21 evaluates a predefined parameter at a step 33. After evaluation, the predefined parameter assumes a value dependent on the frame received. When several frames are received, the predefined parameter assumes a value dependent on the several frames received.

The predefined parameter is preferably a counter for the frames received. Thus, the counter for the frames received by the FPGA 21 has a value corresponding to the number of frames received. Another possible predefined parameter is, for example, an average number of frames per predefined time interval, or any other parameter reflecting the state of the maintenance processor 12.

The predefined parameter is an indication of correct operation of the maintenance processor 12 in that it reflects the expected operation of the maintenance processor 12. When the predefined parameter is a counter for the frames received, the maintenance processor 12 is operating correctly when it sends a predefined number of frames, or a predefined number of frames per time interval. The frame counter can enable the control processor 11 to know whether the maintenance processor 12 is still operating correctly if the control processor 12 receives a counter regularly incremented, for example every predefined time interval.

In operational mode, after the evaluation step 33, the frames received in step 31 are deleted by the FPGA 21. Thus, the control processor 11 has no access to the frames received, and no communication from the maintenance processor 12 to the control processor 11 takes place or is possible.

In maintenance mode, the frames received by the FPGA 21 are stored by the FPGA 21, for example in a memory external to the FPGA 21.

The predefined parameter is then stored by the FPGA 21, for example in an external memory accessible by the FPGA 21.

Step 34 comprises accessing, by the control processor 11, the predefined parameter, that is, an indication of correct operation of the maintenance method. As a function of the value of the indicator, or as a function of a variation in its value, the control processor 11 then knows whether the maintenance processor 12 is in a state of correct operation or incorrect operation. The control processor 11 is able to make this decision by configuration of the control processor 11. In order for the control processor 11 to have access to the predefined parameter, the FPGA 21 may transmit, in a step 34, the stored parameter to the control processor 11 via the bi-directional communication link L1. In one alternative, the predefined parameter may be stored in a memory, for example in a register included in the memory, and the control processor 11 transmits a request via the bidirectional link L1 to the FPGA 21, for access to the memory or for access to the register included in the memory, in order to access the predefined parameter. Thus, the control processor 11 has access to reliable information relating to the operation state of the maintenance processor 12, without compromising the communication isolation between the two processors 11 and 12, thereby keeping a high level of security of the system 2.

The predefined parameter may also depend on an integrity verification implemented by the FPGA 21. This verification is implemented in an integrity verification step 32, before evaluating the value of the predefined parameter in step 33. As a function of the result of the integrity verification, the predefined parameter is then evaluated or not relative to the frame(s) received which were integrity verified.

The integrity verification step 32 comprises implementing the evaluation of a cyclic redundancy check included in each frame received in step 31 or of a checksum included in each frame received in step 31. Thus, the FPGA 21 knows whether each frame received has integrity and has therefore been sent by the maintenance processor 12. The addition of an integrity check to each frame by the maintenance processor 12 and its verification ensure that the control processor 11 has access to reliable information about the correct operation of the maintenance processor 12. Another advantage is that the FPGA 21 requires very little adaptation, and only software adaptations, to be able to verify integrity of the frames received, unlike the state of the art which imposes numerous modifications to the system.

If the verification 32 of integrity of the frame received in step 31 is positive, the predefined parameter is evaluated in a step 33 and the frame is deleted by the FPGA 21. Thus, the control processor 11 does not have access to the frame received but does have access to a predefined parameter dependent on the frame received and indicating correct operation of the maintenance processor 12. By “the integrity of the frame received at step 31 is positive”, it is meant that the frame has integrity, that is, the cyclic redundancy check or checksum included in the frame received can be retrieved from a predefined calculation made from the frame. In the case of a positive integrity check, the method is then continued up to step 34.

If the verification 32 of the integrity of the frame received at step 31 is negative, the predefined parameter is not evaluated at a step 33 and the frame is deleted by the FPGA 21. Thus, the control processor 11 does not have access to the frame received and the predefined parameter is not evaluated because the frame received did not have integrity. By “the integrity of the frame received at step 31 is negative”, it is meant that the frame does not have integrity, that is, the cyclic redundancy check or the checksum included in the frame received cannot be retrieved from a predefined calculation made from the frame. In the case of a negative integrity check, the method is then stopped until a new frame is received at step 31.

The method 3 according to the invention is repeated, during the operational mode, on each new reception of one or more frames sent by the maintenance processor 12 via the unidirectional link L3. For the whole duration of the operational mode, the control processor 11 then knows the operation state of the maintenance processor 12, without compromising the precondition of communicatively isolating the two processors 11 and 12.

1. A method for communicating an indication of correct operation from a first processor to a second processor, the first processor implementing a maintenance function for maintaining the second processor, the second processor implementing a control function for controlling an aircraft engine, the first processor and the second processor being communicatively isolated by a Field-Programmable Gate Array (FPGA), the FPGA comprising:
a first bidirectional communication link with the second processor,
a second unidirectional communication link from the FPGA to the first processor,
a third unidirectional communication link from the first processor to the FPGA,
the method comprising:
receiving, by the FPGA, via the third unidirectional communication link at least one frame sent by the first processor,
evaluating, by the FPGA, a predefined parameter to obtain a value of the predefined parameter, the value of the predefined parameter depending on the frame received,
accessing, by the second processor, via the first bidirectional communication link, the value of the predefined parameter, via the FPGA.

2. The method according to claim 1, wherein the FPGA is configured to implement an operational mode in which frames received via the third unidirectional communication link are deleted by the FPGA after the evaluating, and a maintenance mode in which frames received via the third unidirectional communication link (L3) are stored by the FPGA after the receiving, the method being implemented in operational mode.

3. The method according to claim 1, wherein the parameter is a counter for the number of frames received, the counter being incremented on each new reception of a frame.

4. The method according to claim 1, further comprising, before the evaluating, verifying, by the FPGA, integrity of each frame received via the third unidirectional communication link, the evaluating being carried out, for each frame received, only if the frame received has integrity.

5. The method according to claim 4, wherein the integrity verifying comprises evaluating a cyclic redundancy check included in the frame or a checksum included in the frame.

6. The method according to claim 1, wherein the engine controlled by the control function is an aircraft engine.

7. A system configured to implement the method according to claim 1, the system comprising:
an aircraft engine,
a first processor
a second processor,
an FPGA comprising:
a first bidirectional communication link with the second processor,
a second unidirectional communication link from the FPGA to the first processor,
a third unidirectional communication link from the first processor to the FPGA,
the first processor implementing a maintenance function for maintaining the second processor, the second processor implementing a control function for controlling the aircraft engine, the first processor and the second processor being communicatively isolated by the FPGA.

8. A non-transitory computer program product comprising instructions which, when the program is executed by a computer, cause the same to implement the method according to claim 1.

9. A non-transitory computer-readable recording medium comprising instructions which, when executed by a computer, cause the same to implement the method according to claim 1.
